(19) United States
(12) Patent Application Publication
(10) Pub. No.: US 2025/0297485 A1
(43) Pub. Date: Sep. 25, 2025

(54) BOARD WALL MOUNTING KIT AND METHOD

(71) Applicant: ACCO BRANDS CORPORATION, Lake Zurich, IL (US)

(72) Inventors: Thomas Nelson, Lake Zurich, IL (US); Jonathen Shearer, Lake Zurich, IL (US); Brian Beck, Lake Zurich, IL (US); Matthew Wright, Cleveland, OH (US); David Pehar, Cleveland, OH (US); Anthony DeMore, Cleveland, OH (US)

(73) Assignee: ACCO BRANDS CORPORATION, Lake Zurich, IL (US)

(21) Appl. No.: 19/089,486

(22) Filed: Mar. 25, 2025

Related U.S. Application Data
(60) Provisional application No. 63/569,693, filed on Mar. 25, 2024.

(51) Int. Cl. E04F 21/00; B25H 7/04; B26F 1/32

(52) U.S. Cl. CPC E04F 21/00; B25H 7/04; B26F 1/32

(57) ABSTRACT

A mounting kit and method for accurately positioning a board on a wall are disclosed. The kit comprises a board, a mounting template, an alignment guide to ensure proper board-to-template positioning, and a marking tool for transferring hole locations. The alignment guide includes receiving channels and backstops for precise alignment, and may feature a level indicator. The method involves using the alignment guide to position the board and template, marking hole locations, transferring the template to the wall, and installing fasteners. The kit may include standoff fasteners, such as cleats with interlocking angled or socket-based connections. This system simplifies the installation process by eliminating guesswork and enhancing precision, making it particularly useful for mounting glass boards and other display surfaces.

### TECHNICAL FIELD

The present disclosure relates generally to wall mounting systems and more particularly to board wall mounting systems.

### BACKGROUND

Glass boards like whiteboards are widely used in various settings, including offices, classrooms, and conference rooms, to provide a writable surface for communication and collaboration. Mounting a whiteboard, for example, to a wall can be accomplished using various techniques, including direct fastening, frame-mounted systems, and standoff-based mounting systems. Standoffs are a type of mounting hardware that creates a gap between the whiteboard and the mounting surface, providing a visually appealing “floating” effect. These standoffs typically consist of a base portion that attaches to the wall, a spacer element that extends outward, and a fastening portion that secures the whiteboard to the standoff assembly.

In a conventional standoff mounting system, the whiteboard is pre-drilled with mounting holes, typically located at each corner or at the edges of the board. Corresponding holes are then marked on the wall, either by manually measuring their desired location on the wall or by tracing the holes of the whiteboard while holding the board up to the wall. The holes are then drilled into the wall at locations intended to align with the pre-drilled holes in the whiteboard. The base portion of each standoff is secured to the wall using screws or other fasteners, and the whiteboard is then positioned so that the pre-drilled holes align with the standoff bases. Once aligned, the fastening portions of the standoffs are inserted through the pre-drilled holes in the whiteboard and secured to the standoff bases, thereby holding the whiteboard in place at a spaced distance from the wall.

While standoff mounting systems provide a sleek and modern appearance, conventional methods suffer from significant alignment challenges. Specifically, precise positioning of the standoff bases on the wall is required to ensure that they align with the pre-drilled holes in the whiteboard. Because the whiteboard is typically large and rigid, even minor misalignments between the pre-drilled holes and the standoff bases can prevent proper installation. In some cases, slight deviations in drilling measurements or wall conditions, such as uneven surfaces, can exacerbate misalignment issues, making it difficult to attach the whiteboard securely to the standoffs.

The alignment issues are particularly pronounced in glass whiteboards due to variances in the glass casting and tempering processes during manufacturing. Unlike other materials, such as metal or plastic, which can be precisely drilled post-production, tempered glass cannot be modified after the tempering process without compromising its structural integrity. As a result, the positioning of the pre-formed holes in each glass whiteboard is subject to minor variations from board to board, even when manufactured using the same process. Consequently, the hole spacing in each glass whiteboard is unique, requiring that the corresponding holes in the wall be custom-positioned for each individual board. This lack of uniformity further complicates the mounting process and increases the likelihood of installation errors.

To address the challenge of unique hole spacing in glass whiteboards, conventional mounting methods require a team of three installers to install the board. In a conventional glass whiteboard mounting system the heavy weight of glass whiteboards requires at least two installers to lift and hold a glass whiteboard in position against the wall while a third installer marks standoffs locations on the wall by reaching through the pre-formed holes in the glass and marking the wall surface. Once the hole positions are marked, the whiteboard is lowered, the necessary holes are drilled in the marked wall locations, and the standoff bases are mounted to the wall. The at least two installers may then lift the glass whiteboard once again and secure it to the installed wall standoffs. This method ensures that the hole spacing precisely matches the specific glass whiteboard being installed but requires significant manpower and coordination.

Requiring multiple installers to mount a single glass whiteboard is inefficient, there is a need in the art for an improved mounting system that reduces the required manpower. In particular, it would be advantageous to develop a mounting system that allows for accurate alignment of glass whiteboards while reducing the number of people needed for installation. Such a system would improve installation efficiency, reduce labor costs, and simplify the mounting process without compromising the stability or aesthetic benefits of standoff-mounted glass whiteboards.

### SUMMARY

The present disclosure provides a board wall mounting kit and method of mounting a board on a wall which simplifies the board mounting process by using a template. The kit and method are designed to reduce misalignment between standoffs and boards that arise from unique differences in board mounting hole positions on a board (particularly the unique variances in glass whiteboard holes arising from the glass tempering. Because a template may be made out of a lighter material than a heavier board, the lighter template is easier to position or temporarily adhere to a wall and therefore reduces the number of individuals needed to hold the template against a wall.

In an embodiment, the kit for mounting a board to a wall comprises a board having a front board surface, a back board surface, an outer peripheral edge of the board, and a plurality of board mounting holes extending through the board from the front board surface to the back board surface; a mounting template having a front template surface, a back template surface, and an outer peripheral edge of the template; at least one alignment guide configured to hold the board and the mounting template in alignment with the back board surface opposing the front template surface, such that at least part of the outer peripheral edge of the board is aligned with at least part of the outer peripheral edge of the mounting template; and a marking tool configured to be inserted through at least one of the plurality of board mounting holes to mark the front template surface of the mounting template when the at least one alignment guide holds the board and the mounting template in alignment.

In an embodiment, the board is a glass board.

In an embodiment the at least one alignment guide is configured to hold the board and the mounting template in alignment such that an entire outer peripheral edge of the board is aligned with an entire outer peripheral edge of the mounting template.

In an embodiment the kit further includes at least one standoff configured to mount the board to the wall through at least one of the plurality of board mounting holes.

In an embodiment the standoff forms a cleat, wherein the cleat includes: a supporting mini-cleat with an angled supporting surface; and a hanging mini-cleat with an angled hanging surface that is configured to mate with the angled supporting potion of the supporting mini-cleat.

In an embodiment, the standoff forms a socket mini-cleat, wherein the socket mini-cleat includes: a socket supporting mini-cleat with a cup-shaped supporting portion, and a socket hanging mini-cleat with a knob-shaped hanging portion that is configured to mate with the cup-shaped supporting portion of the socket supporting mini-cleat.

In an embodiment the at least one alignment guide includes a board receiving channel configured to receive the at least part of the outer peripheral edge of the board against a board receiving channel backstop, and a mounting template receiving channel configured to receive the at least part of the outer peripheral edge of the mounting template against a mounting template receiving channel backstop.

In an embodiment, the board receiving channel backstop and the mounting template receiving channel backstop are aligned on a common plane.

In an embodiment the at least one alignment guide includes a board receiving channel indicator and a mounting template receiving channel indicator.

In an embodiment, at least one of the at least one alignment guide includes a level indicator.

In an embodiment, the marking tool is a hole punch.

In an embodiment, the kit further includes a package for transporting the board, the at least one alignment guide, the mounting template, and the marking tool.

In an embodiment, the mounting template forms at least part of the package.

In an embodiment, the method of mounting a board to a wall, comprises the steps of: aligning the board and a mounting template with at least one alignment guide such that a back board surface opposes a front template surface and at least part of an outer periphery of the board aligns with at least part of an outer periphery of the mounting template; marking a location of at least one mounting hole of the board on the front template surface by inserting a marking tool through the at least one mounting hole of the board, the at least one mounting hole extending through the board from a front board surface to the back board surface, such that the marking tool contacts the front template surface; positioning the mounting template adjacent to the wall; attaching a standoff into the wall at the location of the at least one mounting hole of the board marked on the front template surface; and attaching the board to the standoff at the mounting hole of the board to mount the board to the wall.

In an embodiment, the method may include marking the location of the at least one mounting hole of the board includes indenting at least one mark on the front template surface with the marking tool.

In an embodiment method, the mark produced by the method may be centered relative to the mounting hole.

In an embodiment of the method, the marking the location of the at least one mounting hole of the board includes punching a hole in the mounting template with the marking tool.

In an embodiment, a standoff for mounting a board to a wall, comprises: a supporting mini-cleat including a supporting surface, and a hanging mini-cleat including a hanging surface, wherein the supporting surface of the supporting mini-cleat is configured to mate with the hanging surface of the handing mini-cleat.

In an embodiment, the supporting surface of the supporting mini-cleat is an angled supporting surface, and the hanging surface of the hanging mini-cleat is an angled hanging surface that is configured to mate with the angled supporting potion of the supporting mini-cleat.

In an embodiment, the supporting surface of the supporting mini-cleat is a cup-shaped supporting portion, and the hanging surface of the hanging mini-cleat is a knob-shaped hanging portion that is configured to mate with the cup-shaped supporting portion of the supporting mini-cleat.

The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention.

FIG. 1 is front view of a board mounting kit.

FIG. 2 is a perspective view of a corner of the board mounting kit of FIG. 1.

FIG. 3 is a perspective view of a portion of an outer peripheral edge of the board mounting kit of FIG. 1.

FIG. 4 is a perspective view of a board mounting kit which includes a package, wherein the template forms a portion of the package.

FIG. 5 is a disassembled view of the package of FIG. 4 showing how a portion of the package separates from the package for use as the template.

FIG. 6 is a top view of a marking tool of a board marking kit.

FIG. 7 is a perspective view of an alignment guide of a board marking kit.

FIG. 8 is a side view of the alignment guide of FIG. 7.

FIG. 9 is a perspective view of an alignment guide of a board mounting kit which includes a level.

FIG. 10 is a side view of the alignment guide of FIG. 9.

FIG. 11 is a perspective view of a board of the board mounting kit with exemplary standoffs inserted through the board.

FIG. 12 is a perspective view of a corner of the board of FIG. 11 with an exemplary standoff inserted through the board.

FIG. 13 is an exploded perspective view of the exemplary standoff of FIG. 11 relative to the board.

FIG. 14 is a perspective view of an angled mini-cleat standoff attached to a board.

FIG. 15 is a side view of the angled mini-cleat standoff of FIG. 14.

FIG. 16 is an exploded perspective view of the angled mini-cleat standoff of FIG. 14.

FIG. 17 is an exploded side view of the angled mini-cleat standoff of FIG. 15.

FIG. 18 is a perspective view of a socket mini-cleat standoff attached to a board.

FIG. 19 is a side view of the socket mini-cleat standoff of FIG. 18.

FIG. 20 is an exploded perspective view of the socket mini-cleat standoff of FIG. 18.

FIG. 21 is an exploded top view of the socket mini-cleat standoff of FIG. 20.

FIG. 22 is a flow-chart of a method of mounting a board to a wall.

### DETAILED DESCRIPTION

The principles and aspects of the present disclosure have particular application to mounting a board (e.g., a glass board or a whiteboard) to walls and thus will be described below chiefly in this context.

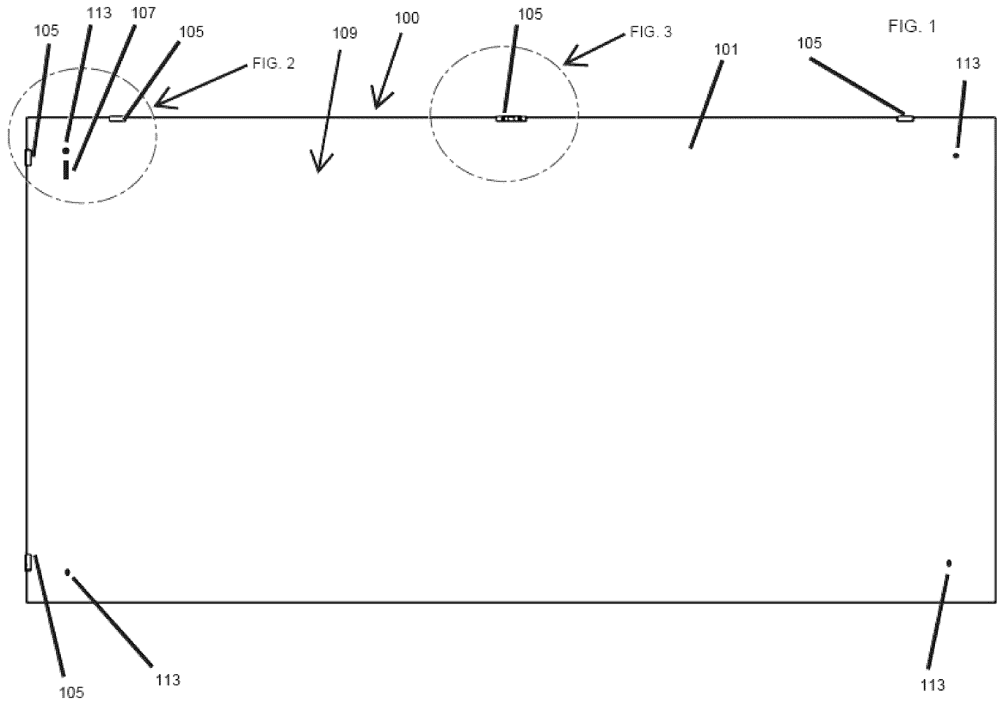

With reference to FIGS. 1-3, a board mounting kit 100 for efficiently mounting a board 101 to a wall (not shown) is depicted. The kit 100 includes a board 101 (e.g., a glass board), a mounting template 103 (may be referred to herein as “template”), at least one alignment guide 105, and a marking tool 107. The board 101 includes a front board surface 109, a back board surface 111, a plurality of mounting holes 113 extending through the board 101 from the front board surface 109 to the back board surface 111, and at least one outer peripheral edge 115. The mounting holes 113 are at predetermined locations relative to each other on the board 101 and form a predetermined pattern on the board 101.

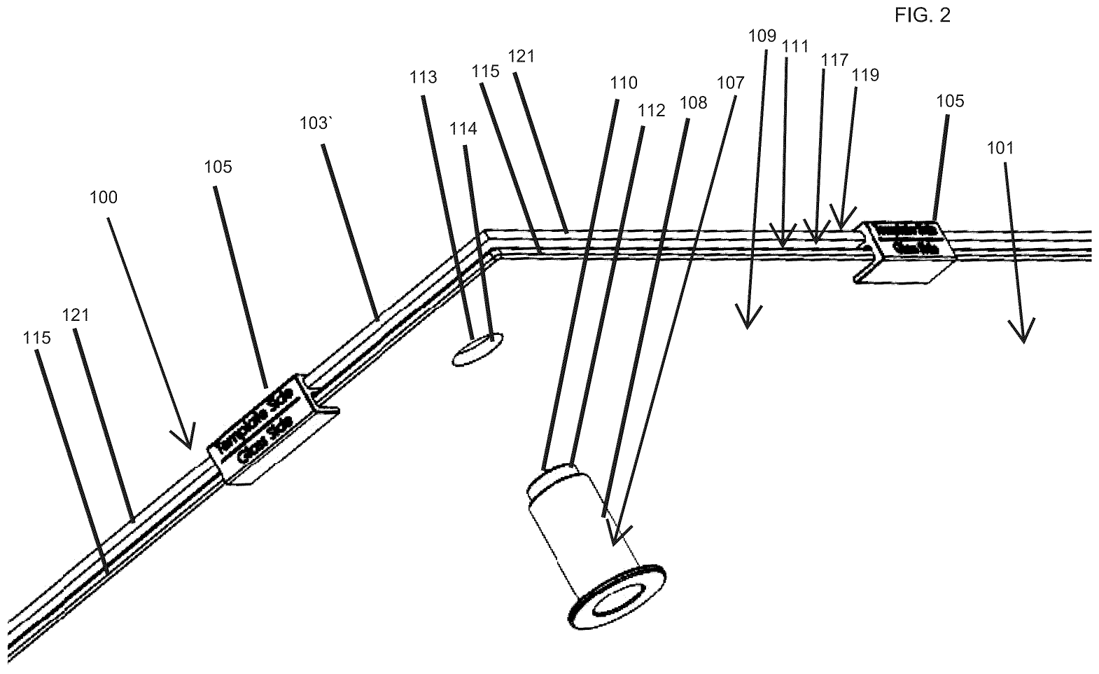

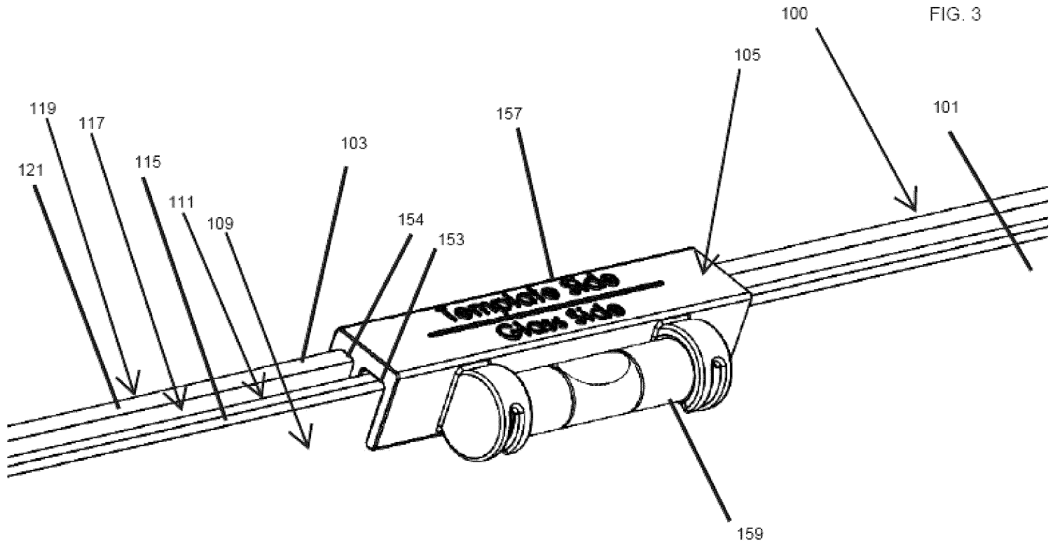

As shown in FIGS. 2 and 3, the template 103 has a front template surface 117, a back template surface 119, and at least one outer peripheral edge 121. The template 103 may have an outer shape symmetrical to the entire board's outer peripheral edge 115, or the template may have an outer shape that is symmetrical to only a portion of the board's outer peripheral edge 115. The at least one alignment guide 105 is configured to be positioned along both the outer peripheral edge 115 of the board 101 and the outer peripheral edge 121 of the template 103 to hold both the board 101 and template 103 together in alignment, such that the back board surface 111 opposes the front template surface 117. Multiple alignment guides 105 may be used to secure separate outer peripheral edges 115, 121 of the board 101 and template 103, respectively. The one or more alignment guides 105 positioned at one or more respective corners of the board 101 and template 103 may be shaped to conform around the corners so as to concurrently align multiple outer peripheral edges 115, 121 of the board 101 and template 103, respectively.

The marking tool 107 is configured to pass through the mounting holes 113 in the board 101 to create marks on the template 103. The alignment of the outer peripheral edges 115, 121 holds the mounting holes 113 immobile relative to the front template surface 117 so that the predetermined pattern of mounting holes 113 may be reflected on the template 103 via a pattern of marks. The reflected pattern of marks on the template 103 may mirror exactly the size and location of the pattern of mounting holes 113 on the board 101. The template 103 may be formed from paper, cardboard, wood, fiberglass, metal, or another suitable material which can receive a mark by the marking tool 107. The template 103 may be rigid or flexible and may match the outer shape of the board 101 or only a portion of it. Specifically, at least part of the outer peripheral edge 121 of the template 103 may be held in alignment with at least a part of the outer peripheral edge 115 of the board 101 with the at least one alignment guide 105. In an embodiment, the at least one alignment guide 105 is configured to hold the board 101 and the template 103 in alignment such that the entire outer peripheral edge 115 of the board 101 is aligned with the entire outer peripheral edge 121 of the template 103.

When the mounting template 103 and board 101 are aligned with the at least one alignment guide 105, the marking tool 107 may be inserted through the plurality of board mounting holes 113 to mark, cut, bore, or imprint the front template surface 117, thereby indicating the predetermined positions of the board mounting holes 113 on the template 103. One or more standoffs 122 may be included in the kit 100 to mount the board 101 to the wall through at least one of the plurality of board mounting holes 113. Because the standoffs 122 are configured to attach to the board mounting holes 113, the standoffs 122 must be attached to the wall in the same predetermined pattern as the mounting holes 113 on the board 101. Accordingly, the marked pattern on the template 103 is used to position the standoffs 122 in an arrangement on the wall that matches the predetermined pattern of the board's mounting holes 113.

In an embodiment, tape or an adhesive may be used to adhere the template to the wall to hold the template stationary to the wall for marking the template 103 marked pattern on the wall.

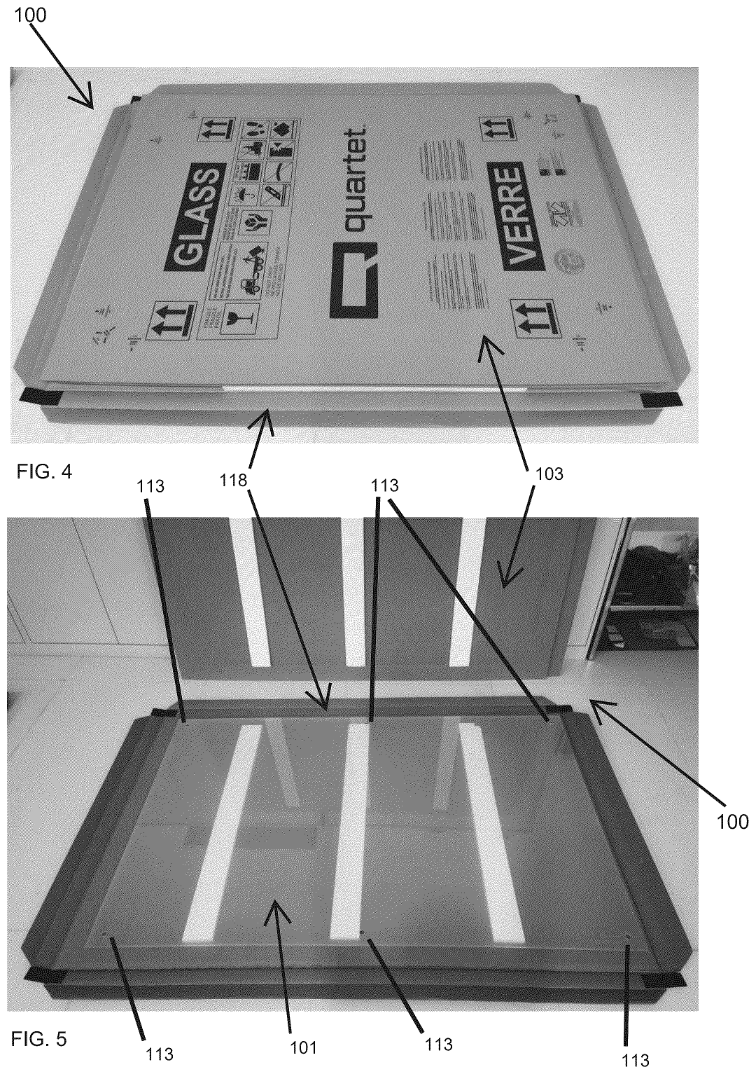

As shown in FIGS. 4-5, a package 116 may be included in the kit 100 to contain the board 101, the template 103, the at least one alignment guide 105, and the marking tool 107 for shipping or transit of the kit 100 to a location where the kit 100 will be used. The template 103 may form a portion of the package or serve as cushioning material (not shown) to protect the board 101 inside the package 116 during transport. In an embodiment (not shown) where the template 103 is a portion of the package 116, the template 103 may be configured to be removeable from, cut from, or torn-away (for example, via perforations in the package material) from a non-template portion 118 of the package 116.

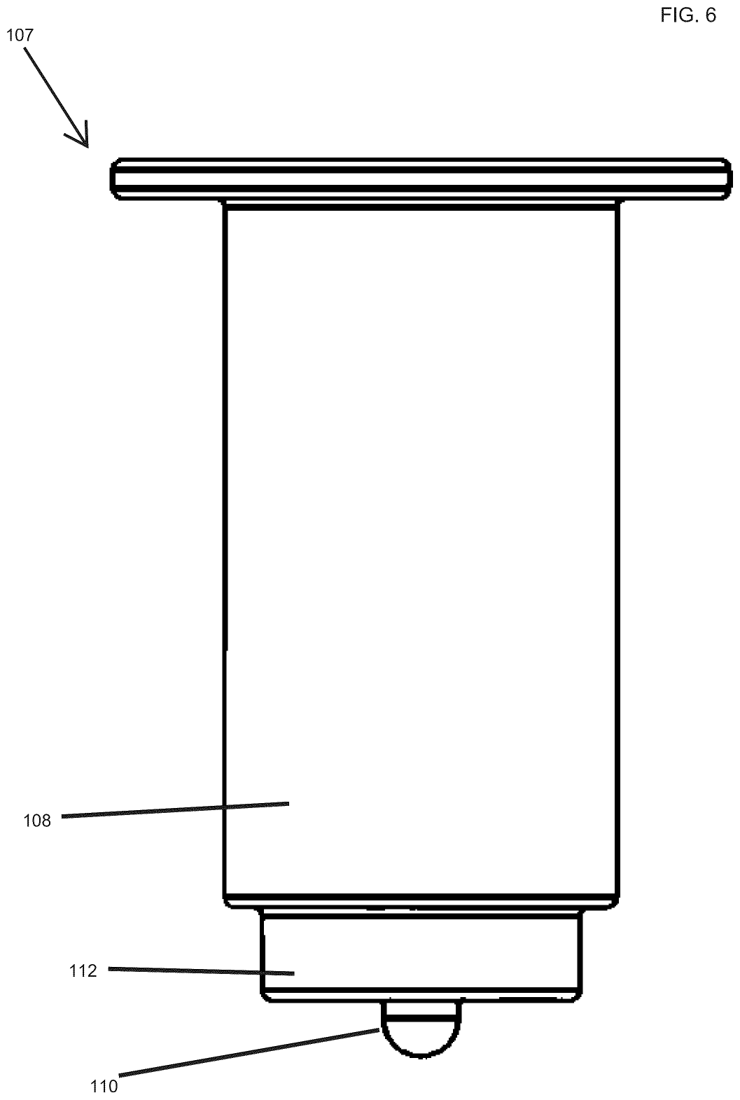

Turning now to FIG. 6, the marking tool 107 may be any object shaped to extend through the mounting hole 113 in the board 101 and leave a mark on the front template surface 117 or through the template 103 from the front template surface 117 to the back template surface 119. For example, the marking tool 107 may be a hole punch. The mark on the template 103 made by the marking tool 107 may be an inked or colored mark, a punched-through hole, a dimple, or any other indicator denoting the position of the mounting hole 113 of the board 101 on the template 103. The marking tool 107 may have an outer diameter 112 matching an inner periphery 114 of the respective mounting hole 113 such that the marking tool 107 may be inserted through the mounting hole 113. In the embodiment shown in FIG. 6, the marking tool 107 additionally includes a projection 110 extending from the body 108 for contacting and marking the front template surface 117 by creating, for example, an impression or dimple on the front template surface 117. The projection 110 may extend from the body 108 of the marking tool 107 along a central axis of the body 108.

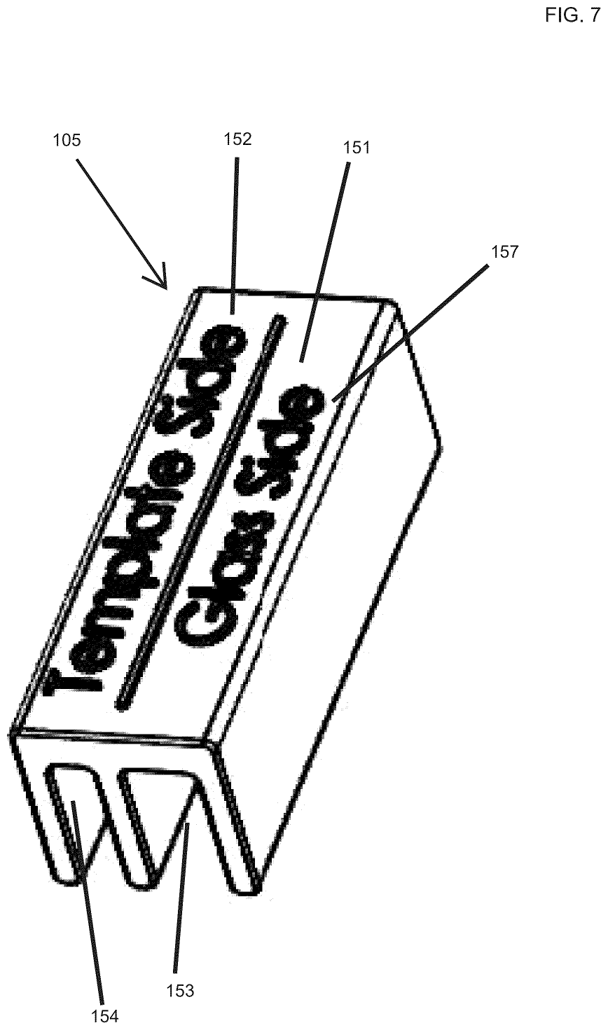

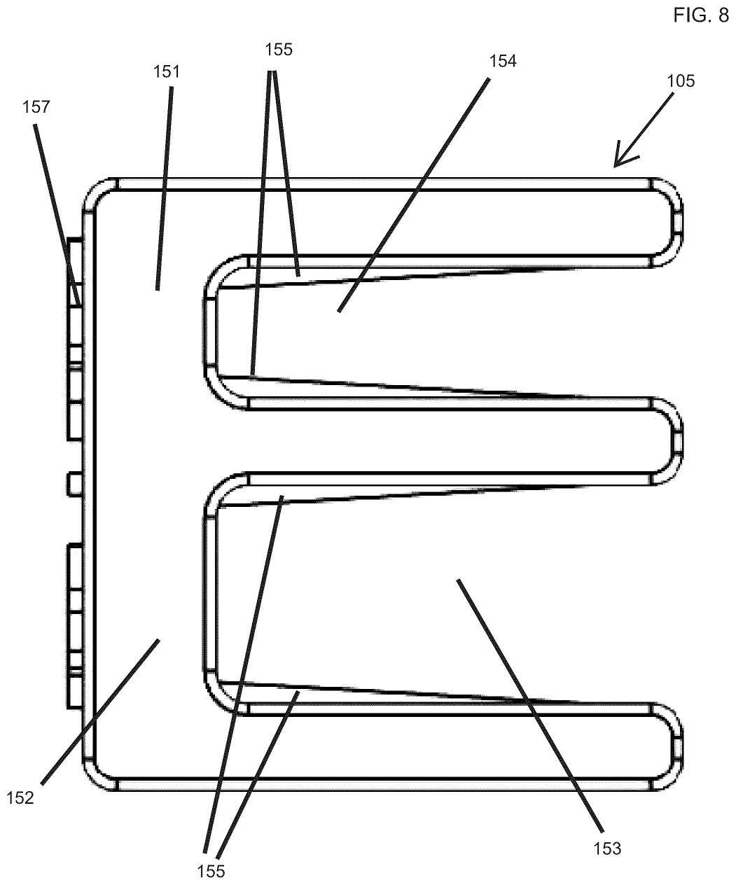

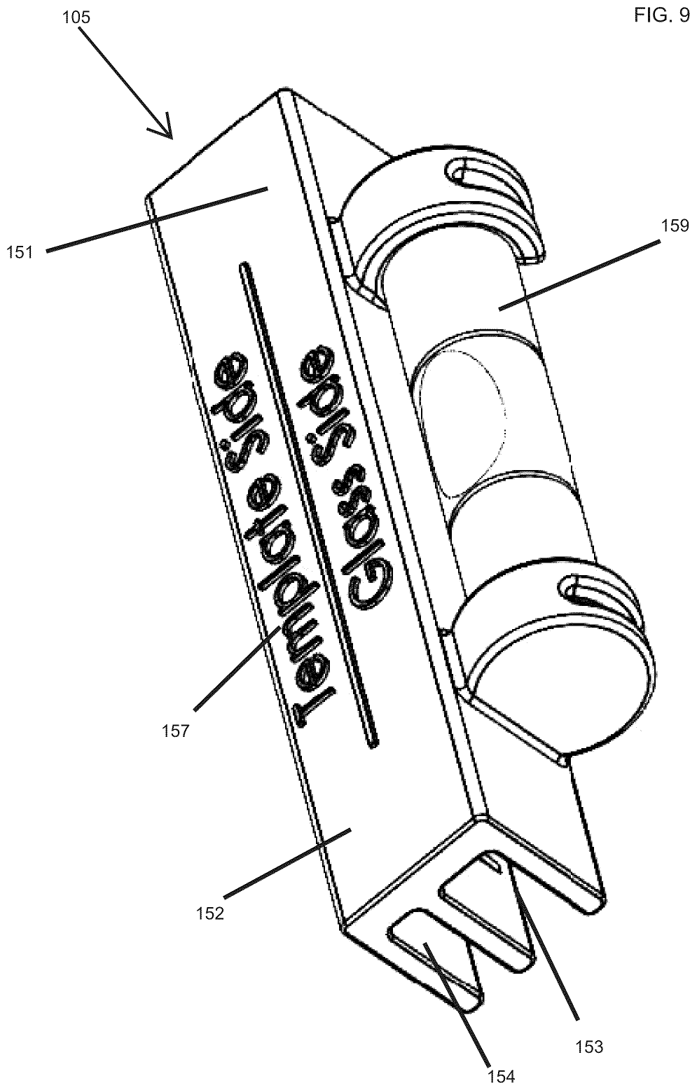

An alignment guide 105 of the at least one alignment guide 105 is depicted in isolation in FIGS. 7-9. As depicted, the at least one alignment guide 105 may include a board receiving channel 153 configured to receive at least a portion of the outer peripheral edge 115 of the board 101 against a board receiving channel backstop 151, and a mounting template receiving channel 154 configured to receive at least part of the outer peripheral edge 121 of the mounting template 103 against a mounting template receiving channel backstop 152. The receiving channels 153, 154 may have equal widths or different widths which correspond to specific template 103 and board 101 thicknesses. As shown in FIG. 7, walls of the receiving channels 153, 154 may include angled centering ridges 155 to center the template 103 or board 101 within the alignment guide channels 153, 154 and provide a snug fit between the board 101 and the template 103. In an embodiment, the template 103 may be formed out of a corrugated material (not shown) and the angled centering ridges 155 may be conformed to engage with the corrugations of the template 103 to limit movement of the template 103 relative to the alignment guide 105. The respective backstops 151, 152 may be configured to rest against the respective outer peripheral edges 115, 121 of the template 103 and board 101 when the alignment guide 105 is in use, and indicator markings 157 may be included on an outer surface of the alignment guide 105 to indicate which receiving channel 154 is configured to hold the template 103 and which receiving channel 153 is configured to hold the board 101.

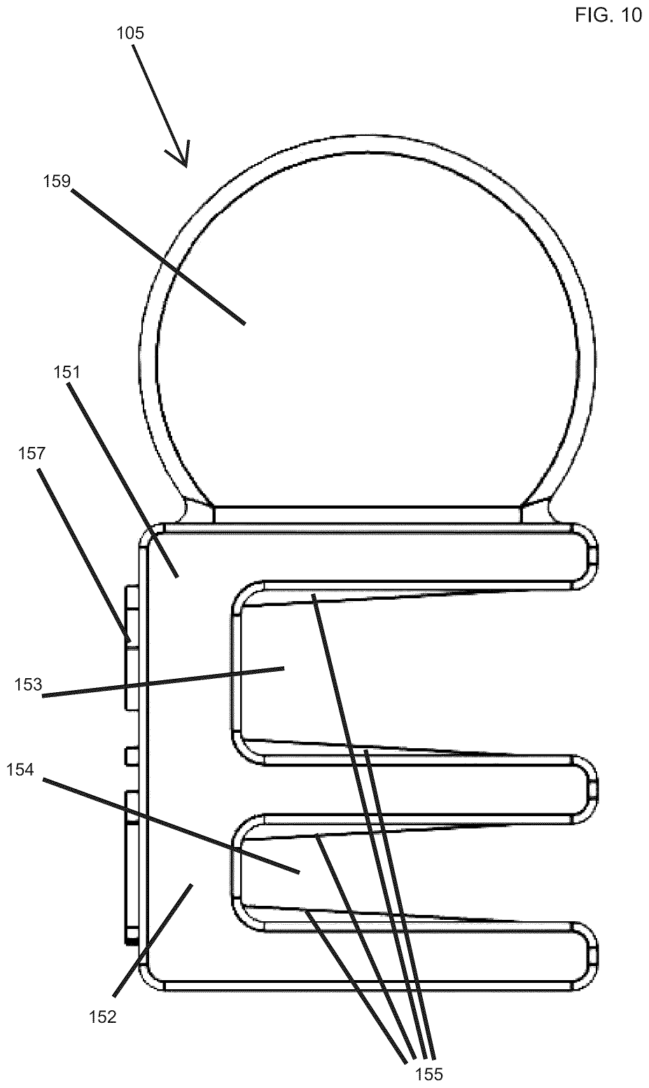

In an embodiment of the alignment guide 105 depicted in FIGS. 3, 9, and 10, the at least one alignment guide 105 may include a level indicator 159 attached to or integrated into the alignment guide 105. The level indicator 159 may be, for example, a bubble level, as depicted, an electronic level, or any other suitable level indicator. This level indicator 159 enhances accuracy when aligning the template 103 and board 101. Because the alignment guides 105 may remain attached to the template 103 when the template 103 is lifted onto the wall to install the standoffs 122 into the wall, the level indicator 159 can be used to position the template 103 relative to the wall such that the standoffs 122 positioned on the wall via the template 103 are transcribed to the wall at a flat and even angle relative to the wall or floor upon which the wall rests.

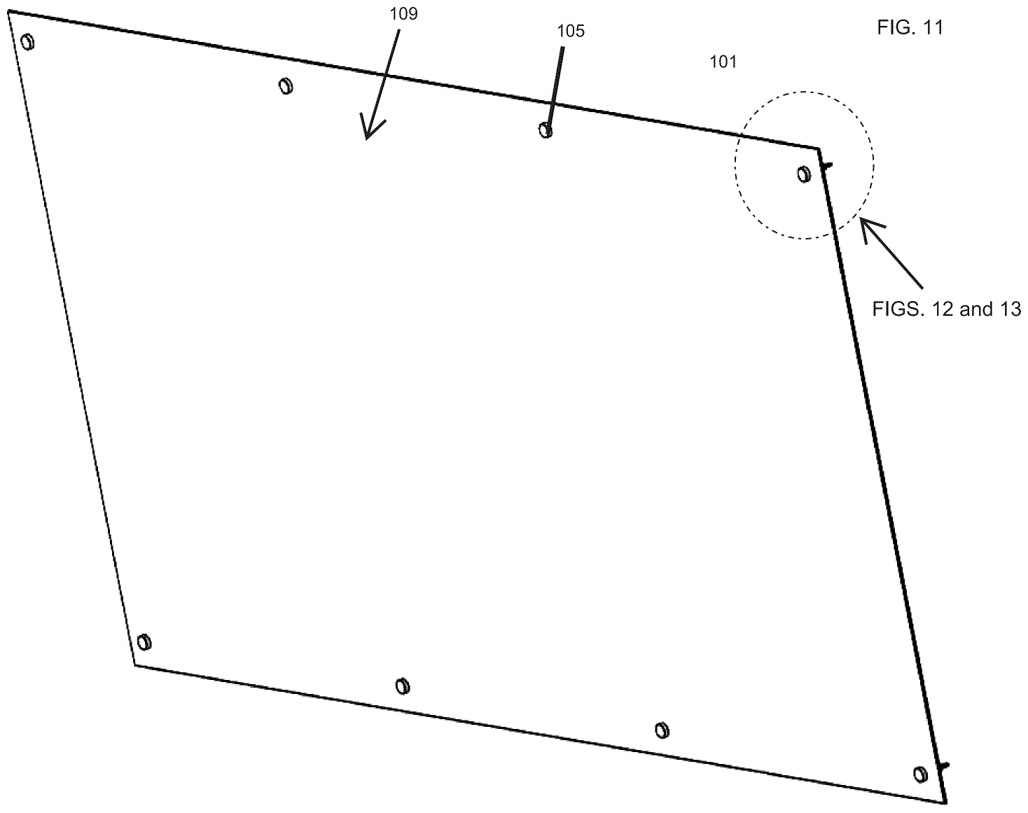

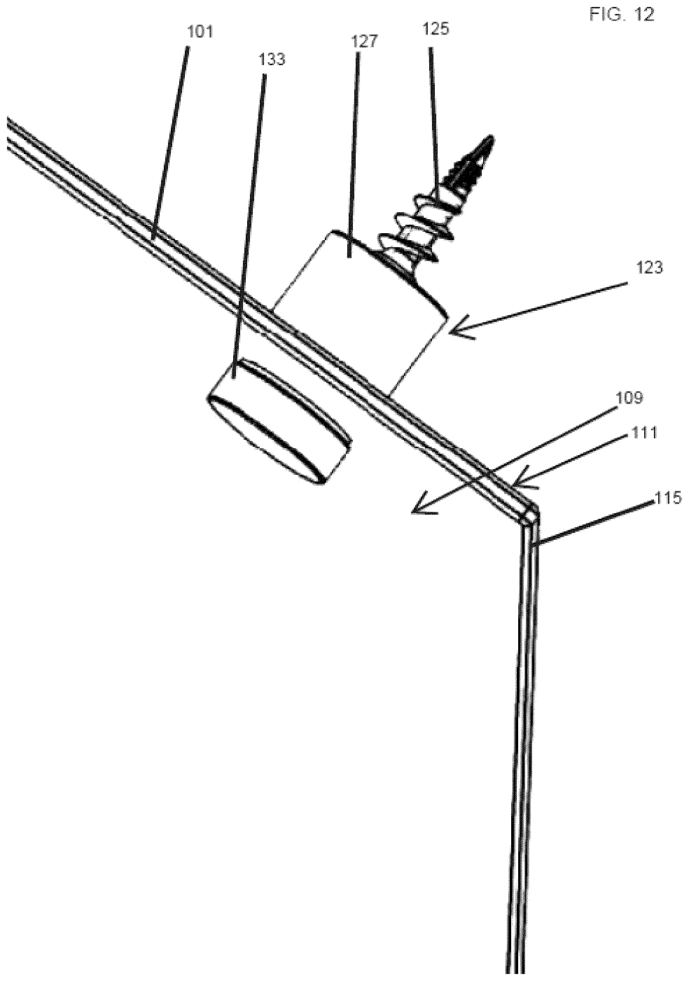

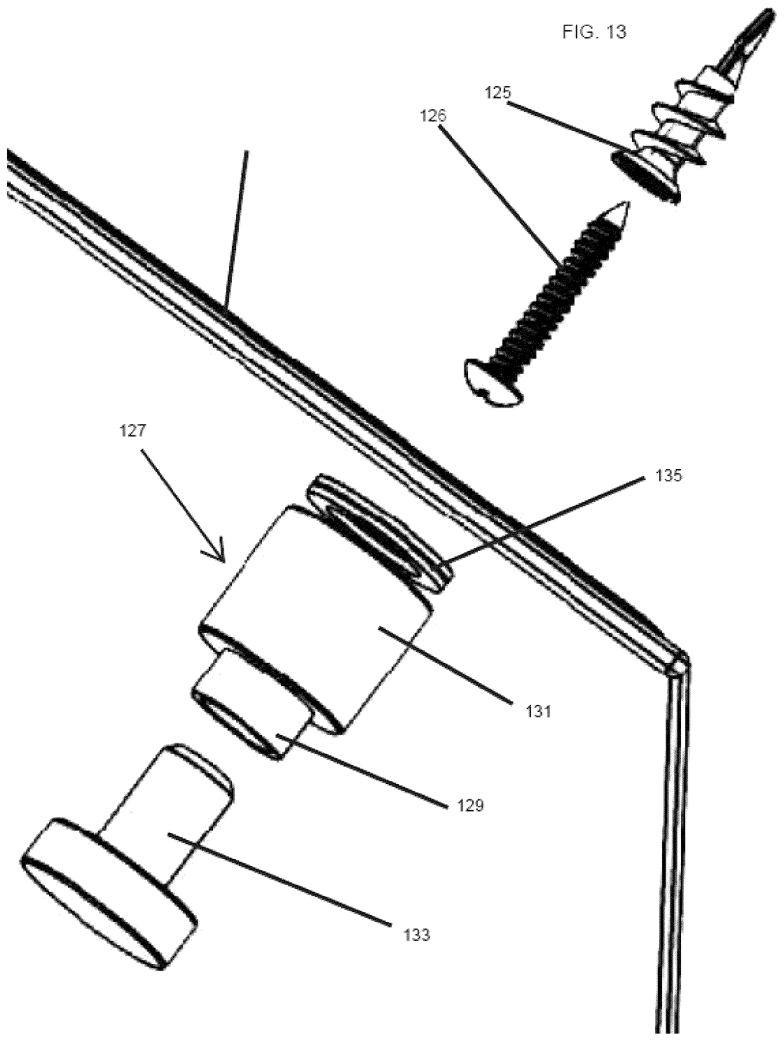

As shown in FIGS. 11-13, the standoff 122 may include a wall fastener 126, a gasket 135 configured to fit the inner periphery 114 of a respective mounting hole 113, a spacer 127 with a larger diameter portion 131 and a smaller diameter portion 129, and a cap 133. The wall fastener 126 may pass through a wall anchor 125, and both the wall fastener 126 and wall anchor 125 may be inserted through the spacer 127. The wall fastener 126 may be a screw, nail, staple, or any other object known in the art for fastening objects to walls. The wall anchor 125 is configured to have the wall fastener 126 pass through the wall anchor 125 and thereby increase the surface area of the wall fastener 126 to increase the amount of force needed to pull the wall fastener 126 out of a wall when a pulling force is exerted on the wall fastener 126.

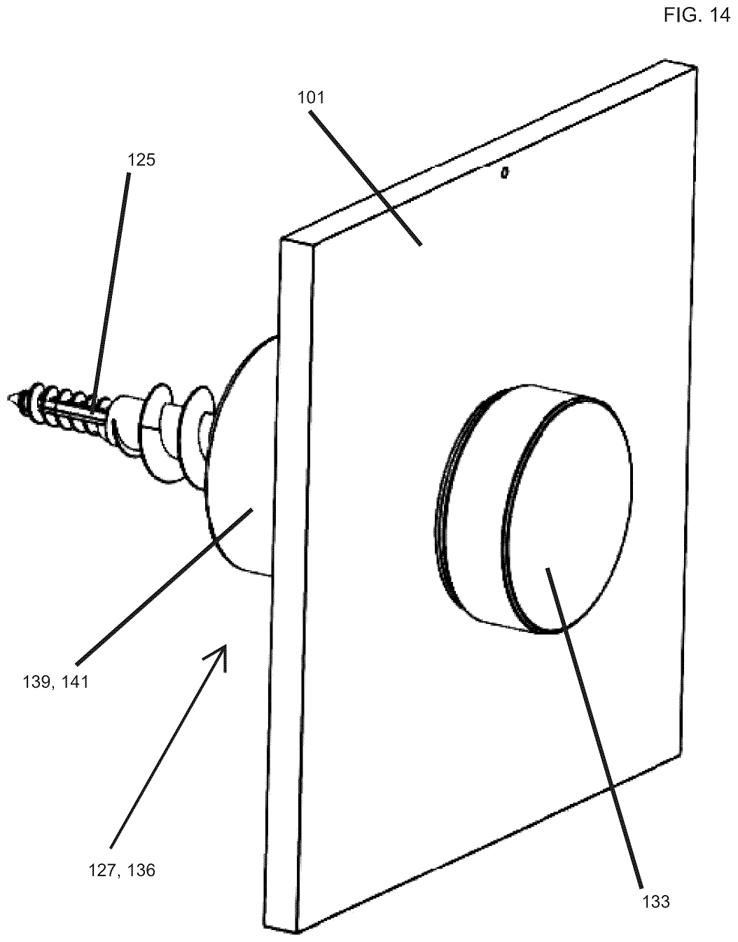

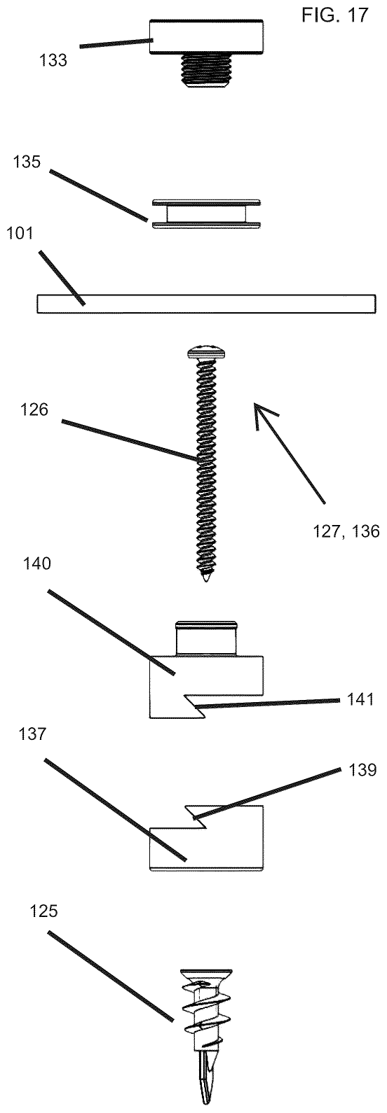

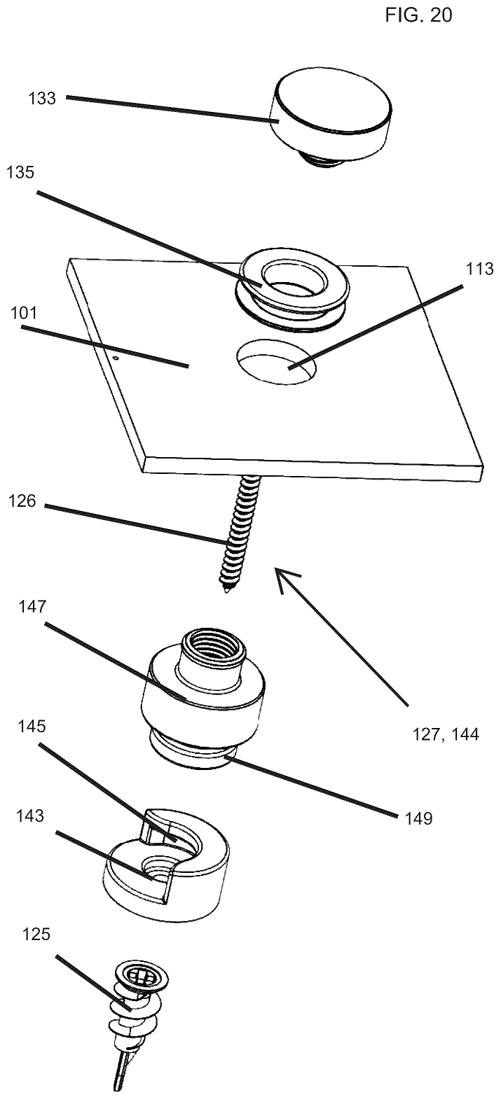

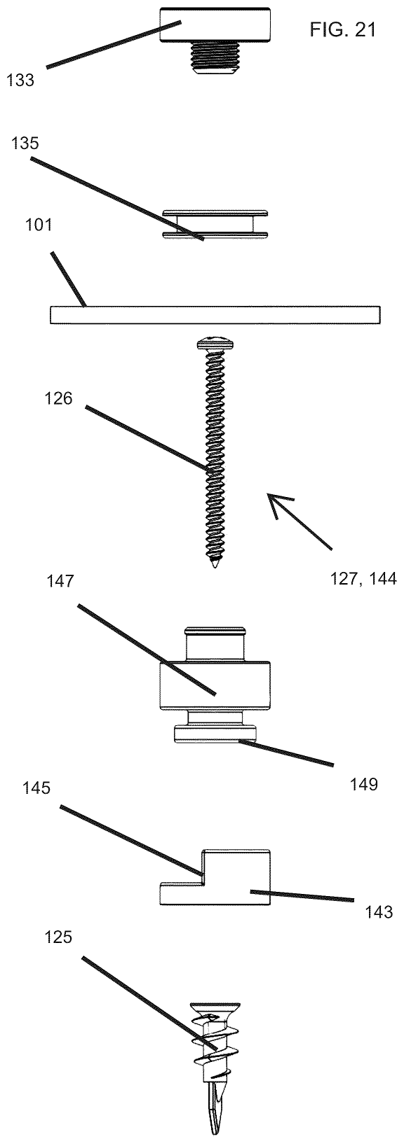

When the board 101 is mounted to the wall using the standoff 122, the larger-diameter portion 131 of the spacer 127 positioned against the back board surface 111, while the smaller-diameter portion 129 of the spacer 127 extends partially or fully through the respective mounting hole 113. The gasket 135 cushions and helps secure the spacer 127 to the board 101. The cap 133 attaches to the smaller-diameter portion 129 of the spacer 127, sandwiching the mounting hole 113 between the cap 133 and the spacer 127. The cap 133 may attach to the spacer 127 via friction fit (FIG. 13), threads (FIGS. 16-17, 20-21), adhesives, magnets, or any other fastening method known in the art.

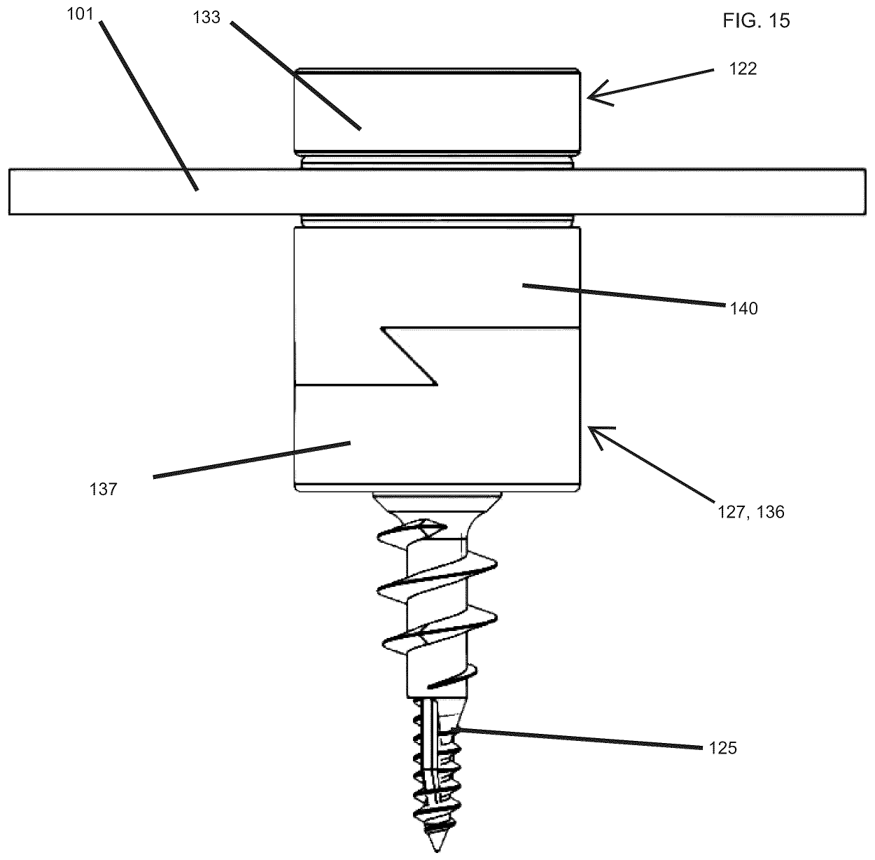

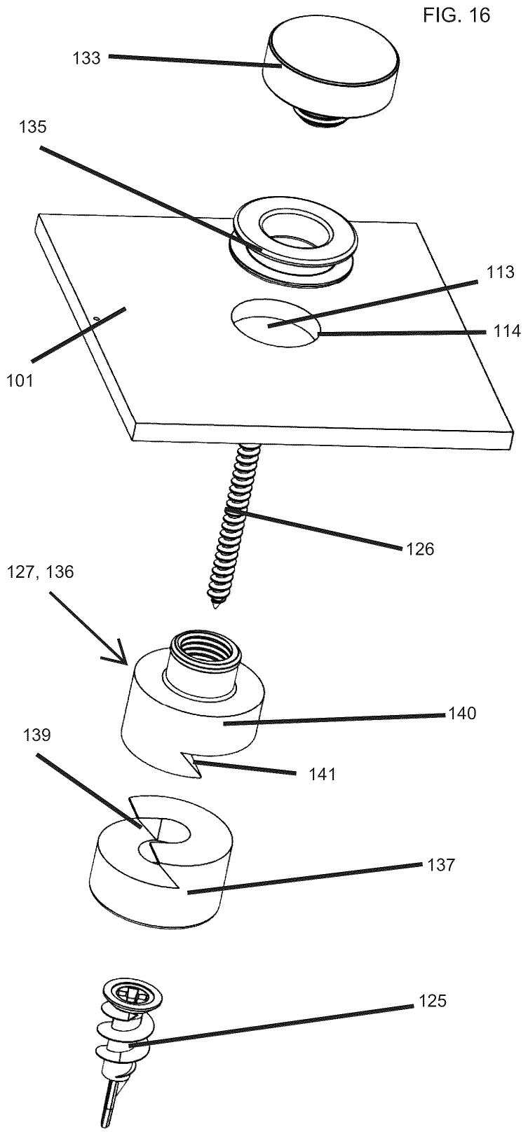

In one embodiment, depicted in FIGS. 14-17, the at least one standoff 122 forms a cleat. Specifically, the spacer 127 of the standoff 122 includes a pair 136 of angled mini-cleats, including a supporting mini-cleat 137 with an angled supporting surface 139 and a hanging mini-cleat 140 with an angled hanging surface 141 that is configured to mate with the angled supporting surface 139 of the supporting mini-cleat 137. That is, both angled surfaces 137, 140 are shaped so that the supporting and hanging angled surfaces 139, 141 align with each other. When mounting the board 101 to a wall using the standoff 122 according to this embodiment, the installer may use the wall fastener 126 (and optionally the wall anchor 125) to attach the supporting mini-cleat 137 to the wall at the marked locations. The hanging mini-cleat 140 is then secured to the board 101 using the standoff gasket 135 and standoff cap 133. The board 101 is mounted by lifting it so that the angled hanging surface 141 of the hanging mini-cleat 140 rests on the angled supporting surface 139 of the supporting mini-cleat 137. The weight of the board 101 and the downward slope of the angled hanging surface 141 and angled supporting surface 139, of the mini-cleats 137, 140 keep the board securely mounted to the wall. Because the mini-cleats 137, 140 are angled, this embodiment offers the exemplary advantage of allowing the board 101 to self-align on the wall, thereby reducing discrepancies between the standoff positions on the wall and the mounting holes 113 in the board.

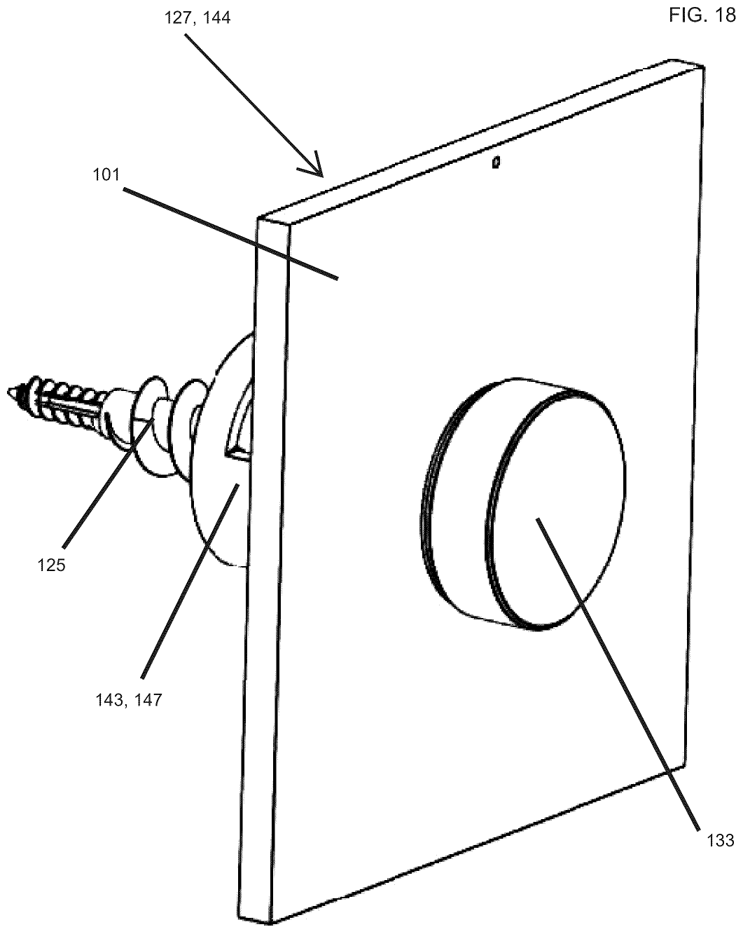

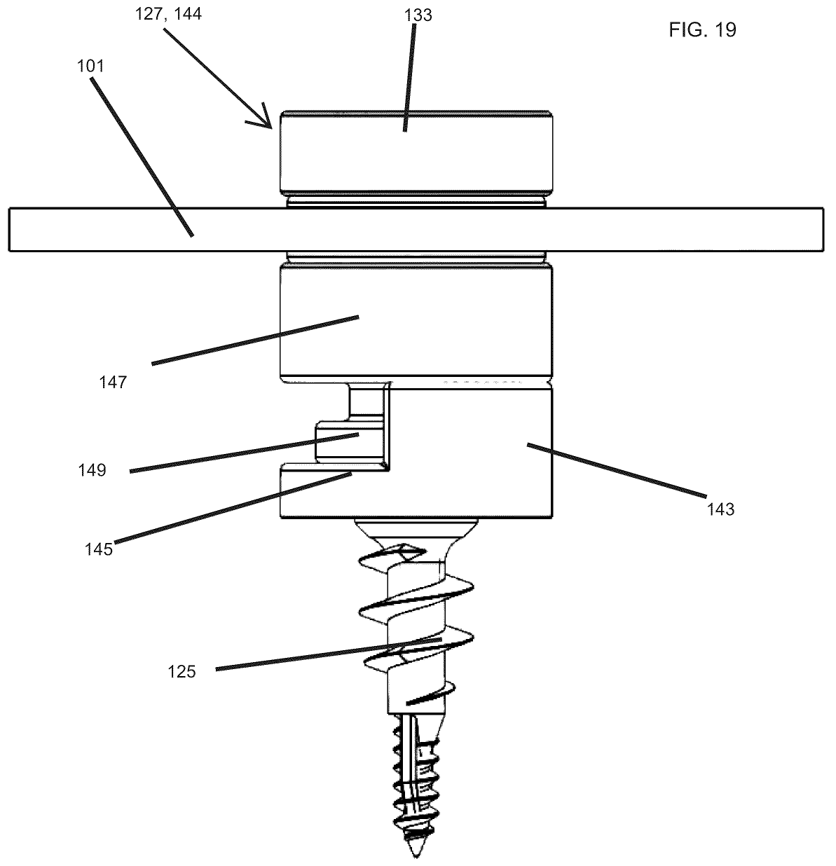

In another embodiment, depicted in FIGS. 18-21, the standoff 122 may take the form of a socket mini-cleat 144. Specifically, the spacer 127 of the standoff 122 includes a socket supporting mini-cleat 143 with a cup-shaped supporting portion 145 and a socket hanging mini-cleat 147 with a knob-shaped hanging portion 149 that is configured to mate with the cup-shaped supporting portion 145 of the socket supporting mini-cleat 143. The cup-shaped supporting portion 145 is configured to receive and hold the knob-shaped hanging portion 149 of the socket hanging mini-cleat 147, and the knob-shaped hanging portion 149 of the socket hanging mini-cleat 147 is configured to fit partially or wholly within the cup-shaped supporting portion 145 of the socket supporting mini-cleat cup 143. The socket supporting mini-cleat 143 is configured to attach to a wall via the fastener 126, and the socket hanging mini-cleat 147 is configured to attach to the board 101. When mounting the board 101 to a wall using the standoff 122 according to this embodiment, the board 101 is mounted by lifting the board 101 to the wall and positioning the board 101 such that the knob-shaped hanging portion 149 of the socket hanging mini-cleat 147 is positioned above the cup-shaped supporting portion 145 of the socket supporting mini-cleat 143. The board 101 is then lowered such that the knob-shaped hanging portion 149 slides into the cup-shaped supporting portion 145 and the cup-shaped supporting portion 145 supports the weight of the board 101 through the cup-shaped supporting portion's 145 retention of the knob-shaped hanging portion 149. This embodiment offers the exemplary benefits of both self-aligning the board 101 while securely retaining the board 101 to the wall. Because the knob-shaped hanging portion 149 of the socket hanging mini-cleat 147 rests inside the cup-shaped supporting portion 145 of the socket supporting mini-cleat 145, the board 101 is difficult to dislodge with a horizontal force relative to the wall. Instead, the heavy weight of the board 101 requires a forceful and deliberate upward movement of the board 101 to demount the board 101 from the wall.

A further advantage of both the embodiment of the standoff 122 of FIGS. 14-17 and the embodiment of the standoff 122 of FIGS. 18-21, is that the standoff 122 does not need to be removed from the wall when the board is taken down (e.g., for painting or cleaning). Instead, the standoffs 122 according to these embodiments allow for easy removal and reinstallation of the board 101 without removing any standoffs 122 from the board 101 or wall.

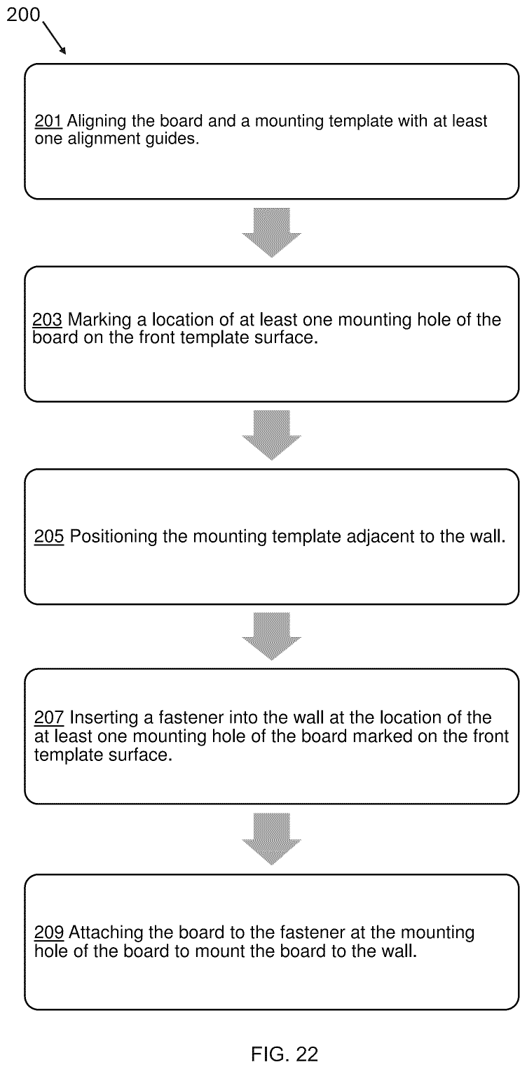

Turning to FIG. 22, a method 200 of mounting a board, such as the board 101 described above, to a wall using a board mounting kit, such as the board mounting kit 100 described above, will be described. The method 200 provides a systematic approach for mounting the board 101 to the wall using the mounting template 103 and the at least one alignment guide 105. The method 200 includes a step 201 of aligning the board 101 and the mounting template 103 with the at least one alignment guide 105 such that the back board surface 111 opposes the front template surface 117 and at least a part of the outer periphery 115 of the board 101 aligns with at least a part of the outer periphery 121 of the template 103. The step 201 of aligning, for example, may be accomplished with the alignment guide 105. Proper alignment ensures that the board mounting holes 113 accurately corresponds to specific locations on the template 103, thereby customizing the template 103 to any unique variances in the location of the mounting holes 113 of each unique board 101.

After the alignment step 201, the method 200 includes a step 203 of marking the location of the at least one board mounting hole 113 of the board 101 on the front template surface 117 by inserting the marking tool 107 through the at least one mounting hole 113 of the board 101 such that the marking tool 107 physically contacts the front template surface 117. This step 203 provides an accurate reference on the mounting template 103, allowing for proper placement of standoffs 122 on the wall that matches the spacing of at least one board mounting hole 113 from at least another board mounting hole 113.

Following the marking step 203, the method 200 includes a step 205 of positioning the mounting template 103 adjacent to the wall. The template 103 serves as a guide for installing standoffs 122 at the marked locations, ensuring that the standoffs 122 align with the board's mounting holes 113. The template 103 may be used to designate standoff 122 wall locations in at least two ways. First, the standoffs 122 may be installed into the wall through the marked sections on the template 103, and then the template 103 removed from the wall leaving only the standoffs 122 attached to the wall. Alternatively, the installer may use the marked locations on the template 103 to guide the creation of markings or drill holes on the wall such that the wall markings or drill holes match the template's markings. The template 103 may then be removed from the wall and standoffs 122 attached to the wall at the wall marked or drilled locations. The template 103 may be removed from the wall after the standoffs 122 are installed, or the template may remain attached to the wall thereby providing an aesthetically pleasing backdrop to the mounted board 101. The method 200 then includes a step 207 of attaching the standoffs 122 into the wall at the location of the at least one mounting hole 113 of the board 101 marked on the front template surface 117.

The method 200 then includes a step 209 of attaching the board 101 to the installed standoffs 122 at the mounting holes 113 of the board 101 to mount the board 101 to the wall. The precise positioning of the standoffs 122, as determined by the template 103, ensures that the board 101 is securely and evenly positioned, avoiding the need for additional adjustments. The disclosed method 200 reduces the risk of misalignment and simplifies the installation process, particularly for glass boards or other surfaces requiring exact positioning. Additionally, the use of the at least one alignment guide 105, marking tool 107, and template 103 eliminates the need for direct measurements, enhancing efficiency and consistency in board mounting applications.

In an embodiment, the step 203 of marking the location of the at least one mounting hole 113 includes indenting the at least one mark on the front template surface 117 with the marking tool 107. The at least one mark may be centered relative to the mounting hole 113 and may define a periphery 114 of the marking hole 113. That is, the method 200 may further include centering the mark relative to the mounting hole 113 or making the mark such that the mark defines an outer periphery 114 of a mounting hole 113. In an embodiment in which the marking tool 107 is a hole punch, the step 203 of marking may include punching a hole in the mounting template 103 with the marking tool 107.

It is to be understood that unless specifically stated otherwise, references to “a,” “an,” and/or “the” may include one or more than one, and that reference to an item in the singular may also include the item in the plural. The phrase “and/or” should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. The word “or” should be understood to have the same meaning as “and/or” as defined above.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A kit for mounting a board to a wall, comprising:
a board having a front board surface, a back board surface, an outer peripheral edge of the board, and a plurality of board mounting holes extending through the board from the front board surface to the back board surface;
a mounting template having a front template surface, a back template surface, and an outer peripheral edge of the template;
at least one alignment guide configured to hold the board and the mounting template in alignment with the back board surface opposing the front template surface, such that at least part of the outer peripheral edge of the board is aligned with at least part of the outer peripheral edge of the mounting template; and
a marking tool configured to be inserted through at least one of the plurality of board mounting holes to mark the front template surface of the mounting template when the at least one alignment guide holds the board and the mounting template in alignment.

2. The kit of claim 1, wherein the board is a glass board.

3. The kit of claim 1, wherein the at least one alignment guide is configured to hold the board and the mounting template in alignment such that an entire outer peripheral edge of the board is aligned with an entire outer peripheral edge of the mounting template.

4. The kit of claim 1, wherein the kit further includes:
at least one standoff configured to mount the board to the wall through at least one of the plurality of board mounting holes.

5. The kit of claim 4, wherein the standoff forms a cleat, wherein the cleat includes:
a supporting mini-cleat with an angled supporting surface;
a hanging mini-cleat with an angled hanging surface that is configured to mate with the angled supporting potion of the supporting mini-cleat.

6. The kit of claim 4, wherein the standoff forms a socket mini-cleat, wherein the socket mini-cleat includes:
a socket supporting mini-cleat with a cup-shaped supporting portion, and
a socket hanging mini-cleat with a knob-shaped hanging portion that is configured to mate with the cup-shaped supporting portion of the socket supporting mini-cleat.

7. The kit of claim 1, wherein the at least one alignment guide includes a board receiving channel configured to receive the at least part of the outer peripheral edge of the board against a board receiving channel backstop, and a mounting template receiving channel configured to receive the at least part of the outer peripheral edge of the mounting template against a mounting template receiving channel backstop.

8. The kit of claim 7, wherein the board receiving channel backstop and the mounting template receiving channel backstop are aligned on a common plane.

9. The kit of claim 1, wherein the at least one alignment guide includes a board receiving channel indicator and a mounting template receiving channel indicator.

10. The kit of claim 1, wherein at least one of the at least one alignment guide includes a level indicator.

11. The kit of claim 1, wherein the marking tool is a hole punch.

12. The kit of claim 1, wherein the kit further includes a package for transporting the board, the at least one alignment guide, the mounting template, and the marking tool.

13. The kit of claim 12, wherein the mounting template forms at least part of the package.

14. A method of mounting a board to a wall, the method comprising the steps of:
aligning the board and a mounting template with at least one alignment guide such that a back board surface opposes a front template surface and at least part of an outer periphery of the board aligns with at least part of an outer periphery of the mounting template;
marking a location of at least one mounting hole of the board on the front template surface by inserting a marking tool through the at least one mounting hole of the board, the at least one mounting hole extending through the board from a front board surface to the back board surface, such that the marking tool contacts the front template surface;
positioning the mounting template adjacent to the wall;
attaching a standoff into the wall at the location of the at least one mounting hole of the board marked on the front template surface; and
attaching the board to the standoff at the mounting hole of the board to mount the board to the wall.

15. The method of claim 14, wherein the marking the location of the at least one mounting hole of the board includes indenting at least one mark on the front template surface with the marking tool.

16. The method of claim 14, wherein the at least one mark is centered relative to the mounting hole.

17. The method of claim 14, wherein the marking the location of the at least one mounting hole of the board includes punching a hole in the mounting template with the marking tool.

18. A standoff for mounting a board to a wall, the standoff comprising:
a supporting mini-cleat including a supporting surface, and
a hanging mini-cleat including a hanging surface,
wherein the supporting surface of the supporting mini-cleat is configured to mate with the hanging surface of the handing mini-cleat.

19. The standoff of claim 18, wherein the supporting surface of the supporting mini-cleat is an angled supporting surface, and the hanging surface of the hanging mini-cleat is an angled hanging surface that is configured to mate with the angled supporting potion of the supporting mini-cleat.

20. The standoff of claim 18, wherein the supporting surface of the supporting mini-cleat is a cup-shaped supporting portion, and the hanging surface of the hanging mini-cleat is a knob-shaped hanging portion that is configured to mate with the cup-shaped supporting portion of the supporting mini-cleat.
